(19) United States
(12) Patent Application Publication
(10) Pub. No.: US 2005/0219542 A1
(43) Pub. Date: Oct. 6, 2005

(54) Detection of a substance in air by refractive index changes

(76) Inventors: Seth Adams, Hatchville, MA (US); Murty V. Bhamidipati, Randolph, MA (US); Myles Walsh III, East Falmouth, MA (US)

Correspondence Address: Myles Walsh, III;Cape Cod Research, 19 Research Road, East Falmouth, MA, 02536, US

(21) Appl. No.: 10/815,081

(22) Filed: Mar. 31, 2004

(51) Int. Cl. G01N 21/55

(52) U.S. Cl. 356/445

(57) ABSTRACT

The invention provides methods for the enhancement of surface plasmon resonance (SPR)-based detection assays of toxic industrial chemicals, biological agents and chemical agents. The methods can be used in any molecular recognition assay that uses a solid support and may be used in air. The invention also provides an SPR instrument that operates in imaging mode and utilizes both positive and negative shifts in SPR to identify analytes.

### FIELD OF THE INVENTION

The invention relates to a method and an apparatus for sensing the presence, concentration or amount of a substance through simultaneous detection of increases and decreases in refractive indices caused by said substance.

### BACKGROUND

Surface plasmon resonance (SPR) is a popular technique in the pharmaceutical industry and in biological research. SPR is but one of a large class of optical sensors collectively referred to as evanescent wave-based detectors. This class includes film waveguide grating couplers, film prism waveguide couplers and long-period grating waveguide couplers. The essential feature of all of these techniques is that a standing “evanescent” wave is generated above the sensing surface by a short distance (approximately 50-200 nm) from the waveguide surface. By changing the local refractive index within this volume, the evanescent wave is altered, requiring either a new angle of incident light to set up the “resonance condition” or inducing a phase shift of the reflected light.

Heretofore SPR instruments have been limited to molecular recognition assays performed in liquid test solutions. The methods of this invention extend the usefulness of SPR instruments to detection of chemical agents, biological agents and toxic industrial chemicals in carrier gases, especially air.

The instant invention provides for ultra-sensitive detection of target compounds in a carrier gas. Definitions for “SPR substrate”, “SPR reflectivity”, “SPR profile”, and “prism” are given and imaging SPR for a plurality of different analytes in a test solution is described in U.S. Pat. No. 6,579,721 issued Jun. 17, 2003, incorporated by reference herein in its entirety.

A “chemical agent” is a chemical substance intended to kill, seriously injure, or to incapacitate through its physiological effects. Chemical agents are chosen from the group comprising nerve agents, blood agents, blister agents, choking agents, and toxic industrial chemicals.

A “biological agent” is a disease-causing microorganism such as bacteria, rickettsia and viruses. Biological agents include animal and plant pathogens that could be used for anti-crop and anti-animal biological warfare. Classical biological agents include anthrax, botulinum toxin, brucellosis, smallpox, tularemia, Q fever, ricin, viral hemorrhagic fevers, and plague.

“Toxic industrial chemicals” are selected from the group consisting of allyl alcohol, acrolein, acrolonitrile, ammonia, arsine, chlorine, diborane, ethylene oxide, formaldehyde, hydrogen bromide, hydrogen chloride, hydrogen cyanide, hydrogen fluoride, hydrogen selenide, hydrogen sulfide, methyl hydrazine, hydrazine, methyl isocyanate, methyl mercaptan, nitrogen dioxide, nitric acid, parathion, phosgene, phosphine, sulfuric acid, sulfur dioxide, sulfur trioxide and toluene diisocyanate.

Toxicity thresholds of toxic industrial chemicals from inhalation and dermal contact vary from about 0.2 ppm/hour to about 100 ppm/hour. Said chemicals generally have a median lethal dose 10 to 100 times less toxic than the nerve agents, but are more widely available.

### SUMMARY OF THE INVENTION

The present invention is directed to an imaging surface plasmon resonance instrument for the simultaneous detection of multiple target analytes using a sensor comprising a solid support to which “positive”, “nonreactive”, and “negative” layers for the sensing of different target analytes are attached at specific locations. A large number of said layers, a few of which during an assay respond to the target analytes as well as to anticipated chemical, physical and biological interferences, make the sensing method of the invention both highly sensitive and highly selective to a very wide range of target analytes.

By “positive layer”, “nonreactive layer” and “negative layer” are meant layers in the SPR sensing area which interact with a sample or an analyte species in the sample such that the effective refractive index detected by the sensor is respectively increased, unchanged or decreased. In preferred embodiments, positive, nonreactive and negative layers comprise chemical groups with sensitivity to a variety of biological or chemical species. In preferred embodiments, the same layer can be positive, nonreactive, or negative depending on the analyte.

A principle object of the present invention is to sense ppm levels of gases in carrier gases. The applicability and usefulness of SPR in preferred embodiments is greatly expanded by use of an extended coupling matrix in conjunction with the sensing surface. By “extended coupling matrix” is meant an array of molecules extending about 50 to about 400 nm away from the surface of the metal film used.

Especially preferred are extended coupling matrices comprising clusters of atoms selected from the group consisting of gold, platinum, palladium, silver, aluminum, and copper. Clusters containing about 30 to about 100 metal atoms are preferred. Said extended coupling matrices make possible the useful detection of molecules with molecular weights of between about 30 and about 1000.

Especially preferred are extended coupling matrices comprising chemical moieties which have a specific chemical affinity for one or more chemical agents, biological agents or toxic industrial chemicals.

It is an object of the present invention to provide instruments, methods and reagents for detecting chemical agents, biological agents and toxic industrial chemicals in air.

Another object of the present invention is to simultaneously monitor for multiple compounds by providing multiple sensing and reference sensors on the same waveguide.

It is still another object of the present invention to provide a self-referencing design to quantify changes in SPR due to environmental changes other than chemical changes.

Other objects, advantages and features of the present invention will be more readily appreciated and understood when considered in conjunction with the following detailed description and drawings.

### BRIEF DESCRIPTION OF THE DRAWINGS

FIG. 1a illustrates schematically a preferred structure of the extended coupling matrix. Gold clusters (10) comprising about 50 atoms are covalently bound through sulfur bonds S to alkyl chains (20) of length from 2 to about 20 carbons. Said chains terminate with chemical groups, R, chosen according to the invention from functional groups which either bind to or substitute for target analytes. In some preferred embodiments, binding raises the index of refraction of the layer and results in useful increases in measured SPR angle. In other preferred embodiments, substitution lowers the index of refraction of the sensing layer results in useful decreases in measured SPR angle.

FIG. 1b is an Atomic Force Microscope view of the surface of a continuous gold film coated according to the invention with a layer of the gold clusters (10) described in FIG. 1a. FIG. 1B illustrated that said extended coupling matrix comprises a random array of surface structures.

FIG. 2 illustrates the SPR response curve for a 34 nm Au film SPR substrate coated with sensing layers A, B, C that result from exposure to a mixture of air and the toxic industrial chemical HBr.

FIG. 3 schematically illustrates the instrument of the invention which provides a means (30) for scanning of the angle of incidence of a p-polarized light beam (40) over sensing surfaces (50) supported on a wave guide (60). Light (40) preferably follows a path from a p-polarized light source (90) to a plurality of light sensitive detectors (100). The path of the light (40) may be directed to reflect from said waveguide by utilizing a “prism” (70) as well as by utilizing lenses (80).

### DETAILED DESCRIPTION OF THE PREFERRED EMBODIMENTS

In preferred embodiments target compounds are chemical or biological weapons and the carrier gas is air. Terrorist use of chemical and biological weapons is among the most alarming of emerging transnational threats. Rudimentary chemical and biological weapons require minimal technology and are available to any group desiring to produce them. For chemical weapons the area affected is relatively small, detectability is difficult, time to detect and identify must be in seconds, time until onset of effects is normally in minutes.

One of ordinary skill in the art can readily determine the appropriate thickness of the SPR supporting metal layer for a given SPR sensor application by varying the conducting metal layer thickness to optimize the resonance curve. Prior to adherence or deposition of the conducting layer, a base or adherence layer is optionally applied to the substrate surface. The adherence layer is typically a metal layer, such as chromium, nickel, platinum or titanium, less than 50 Å thick and more preferably about 20 Å thick.

Positive, nonreactive, and negative layers can be adhered to the SPR-supporting conductive layer or to an overlayer on the conductive layer. Said layers should interface with the sample.

A number of methods described, are known and are available to those of ordinary skill in the art, for formation of positive layers with sensitivity to a variety of biological or chemical species. For example, U. S. Pat. Nos. 4,844,613, 5,327,225, 5,485,277, and 5,492,840 disclose or summarize methods for preparation of such positive layers in SPR sensors. Said methods detect the increase in index of refraction which is caused by the interaction of chemical receptors with large biological molecules.

For chemical agents containing phosphorus, especially preferred is the thiol-ligand illustrated below: 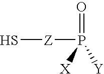
where Z is a linear chain comprising monomers selected from the group consisting of alkyl, alkyl ether, and silyl alkane, and where X and Y are selected from the group consisting of methoxy, ethoxy, and propyloxy.

Negative layers are formed according to this invention by providing chemical receptors, R, which react with the analyte and release products to the analyte. Preferred chemical receptors have specific interactions with only a small fraction of chemical agents, biological agents and toxic industrial chemicals. Especially preferred are chemical receptors whose products possess useful vapor pressure and molecular weight exceeding about 100 daltons.

It will be appreciated that a layer can be positive to one analyte, negative to a second analyte and nonreactive to a third analyte. An important aspect of the present invention is the ability to multiplex assays using the SPR techniques of the present invention. Spatial multiplexing is made possible by the physical separation of positive, nonreactive, and negative layers on the metal substrate. Such multiplexing is best interrogated by rapidly changing the angle of incidence and measuring the intensity of the reflected light as a function of incident angle.

In the current atmosphere of increased concern about bio-terrorism, false alarms are not only costly, but dangerous as well. The inability of conventional SPR to distinguish between changes in bulk effects (temperature, humidity) and specific binding of targeted compounds makes accurate auto referencing a crucial component in any SPR based chemical sensor. Auto referencing is provided according to the invention by simultaneously monitoring the SPR responses of more than three layers on the metal substrate. A number of methods have been described, are known and are available to those of ordinary skill in the art, for optically connecting a planar waveguide to a detector array comprising a plurality of photodetectors. Commercial systems are available to record in a database the responses of each and every one of said photodetectors to variations in the angle of incidence of the SPR. Computer software is available to those of ordinary skill in the art to compare the responses and identify any changes which take place with time and with variations in the chemical composition of the analyte.

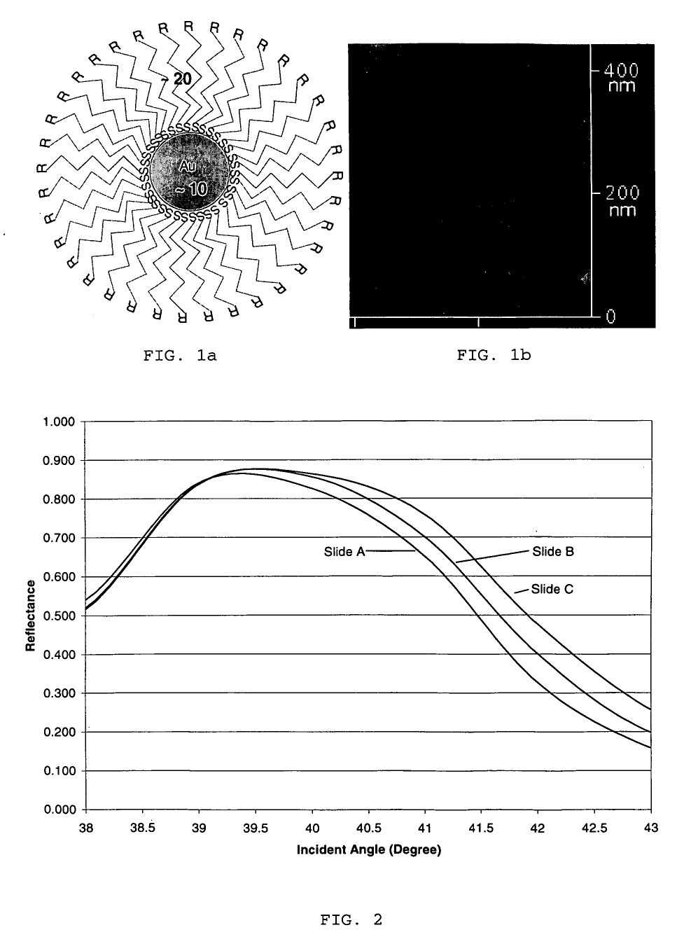

By way of example but not by way of limitation, FIG. 1a illustrates gold nanoclusters (10) which are covalently bound through sulfur bonds S to alkyl chains (20) of length from 2 to about 20 carbons. The sensitivity of the method is related to the slope of the SPR response as the angle of incidence of the light is varied. Alkyl chains (10) containing 6 or 8 carbons and formed from 1,6-hexanedithiol or 1,8-octanedithiol are preferred. Said chains produce the steepest resonance and the most sensitive coupling.

Choices of the chemical groups, R, are chosen, according to the invention, from functional groups which either bind to or substitute for target analytes.

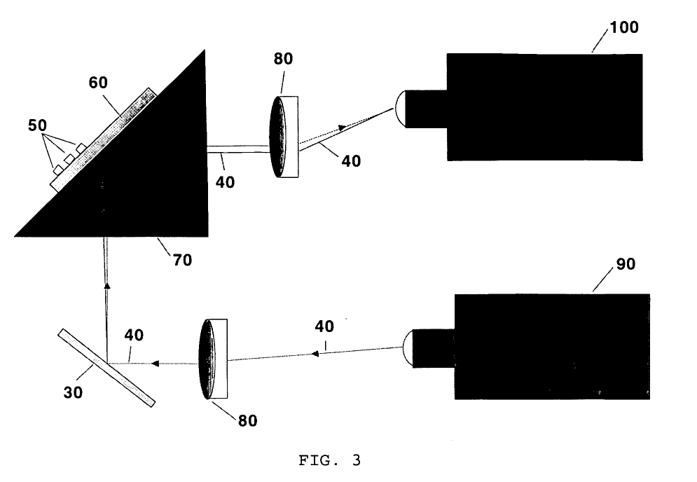

FIG. 2 illustrates the changes in SPR response that accompany exposure of the positive, nonreactive, and negative layers of the invention to a mixture of air and acid. By way of example, but not by way of limitation, three clear microscope slides of BK7 glass were coated with a 4 nm adhesion layer of chromium followed by a 34 nm layer of gold. The gold surfaces were coated with a monolayer of cysteamine (Slide A), with cysteamine and exposed to HBr for 3 minutes (Slide B), or with cysteamine and exposed to dodecylbenzene sulfonic acid for 3 minutes (Slide C). The glass slides were mounted on a glass prism in air and illuminated using a p-polarized laser source.

FIG. 3 illustrates schematically a scanning SPR instrument. In a preferred embodiment, the angle of incidence of the p-polarized illumination is varied with a rotating mirror and the plasmon excitations at the metal film interfaces observed by a monochrome camera.

1. A method for conducting a plurality of assays for a plurality of different analytes in a carrier that may contain said different analytes, comprising:
providing a surface plasmon resonance active surface;
associating a plurality of different extended coupling matrices to said surface;
contacting said surface with said carrier, wherein the presence or absence of a specific analyte results in an increase, a decrease or no change in the indices of refraction of said extended coupling surfaces;
detecting said changes in said indices of refraction by measuring the SPR profile, wherein the SPR profile is distinguishable between said different extended coupling matrices.

2. The method of claim 1 wherein said active surface is a thin metal film.

3. The method of claim 2 herein said thin metal film is selected from the group consisting of gold, copper, silver, aluminum.

4. The method of claim 1 wherein coupling matrices are covalently bound through sulfur bonds to alkyl chains of length from 2 to 20 carbons.

5. The method of claim 4 wherein coupling matrices comprise of atoms selected from the group consisting of gold, platinum, palladium, silver, aluminum, and copper.

6. The method of claim 1 wherein said carrier is air.

7. The method of claim 1 wherein said analytes are selected from the group consisting of chemical agent, biological agent and toxic industrial chemical.

8. An apparatus for sensing the amount, concentration or presence of a substance through optically monitoring simultaneous increases in refractive index at positive layers, no change in refractive index at nonreactive layers, and decreases in refractive index at negative layers.
